(19) United States
(12) Patent Application Publication
(10) Pub. No.: US 2009/0139138 A1
(43) Pub. Date: Jun. 4, 2009

(54) DEVICE FOR TRAINING CREEPING PLANTS

(75) Inventor: Miquel Massaguer Agullo, Terrassa (ES)

Correspondence Address: BAKER & DANIELS LLP;111 E. WAYNE STREET, SUITE 800, FORT WAYNE, IN, 46802, US

(73) Assignee: A. Raymond et Cie, Grenoble (FR)

(21) Appl. No.: 12/299,840

(22) PCT Filed: May 11, 2007
(86) PCT No.: PCT/EP2007/004172

§ 371 Date: Nov. 6, 2008

(30) Foreign Application Priority Data
Jun. 29, 2006 (FR) 06/05889

(51) Int. Cl. A01G 9/12

(52) U.S. Cl. 47/46

(57) ABSTRACT

A device for training creeping plants by means of a substantially vertical, flexible support wire comprises a reel with quick attach means to effect attachment to a carrying cable. A winding spool for the support wire is mounted so that it is able to rotate. The reel comprises: an immobilizing lever (33) mounted pivotably about a pivot axis between a position of clamping the support wire and a position of releasing it, the support wire being disposed, in the clamping position, between a first jaw (39), which is integral to the immobilizing lever (33), and a fixed second jaw (27) opposite the first jaw (39); and automatic return means (36) that return the immobilizing lever (33) toward the clamping position.

### CROSS-REFERENCE TO RELATED APPLICATION

This application is a U.S. National Phase Patent Application based on International Application Serial No. PCT/EP2007/004172 filed May 11, 2007, the disclosure of which is hereby explicitly incorporated by reference herein.

### BACKGROUND OF THE INVENTION

1. Field of the Invention

The present invention relates to a device for training creeping plants by means of a substantially flexible, vertical support wire, comprising a reel with quick attach means, to effect attachment to a carrying cable, and a winding spool on which said support wire is wound and which is mounted rotatably about an axis of rotation.

2. Description of the Related Art

Quick attach means to effect attachment to a carrying cable generally comprise a hook that can be moved along said cable, which is stretched horizontally at a considerable height (about 3 meters off the ground). The flexible support wire, constituted by a rope or string, is unwound from the reel. The plant is attached and guided during its growth.

Recent years have seen the development of a cultivation method known as “lateral extension growth,” which is currently being used primarily to grow tomatoes in greenhouses.

In this method, the young plant is attached to the vertical support wire unwound from the reel, which is attached, substantially vertically from said plant, to the carrying cable stretched horizontally near the roof of the greenhouse, that is, generally several meters off the ground. This sustaining cable is disposed above a row of plants whose spacing depends on the type of plant concerned.

The plant is guided during its growth by the support wire, and is secured to it by means of suitable fasteners as it increases in size.

When the fruit-bearing, aerial portion of the plant reaches a height that makes it hard to reach, a given additional length of support wire is paid out and the reel is moved along the carrying cable. The unproductive lower portion of the plant thus forms a curve that comes to rest on the ground. This operation is repeated several times during the growth of the plant, which may reach lengths of more than dozen meters (for example in the case of tomatoes).

This cultivation method makes it possible to increase the yield of cultivated areas and to save on labor and the purchase of young plants.

The document FR-A-2743258 describes a device of the aforementioned type in which one of the flanges of the spool is fitted with a latch. The spool holder comprises a locking lever having one transversely oriented part that is disposed on the circular path of the latch. A second part extends upwardly in a direction parallel to an intermediate portion of the spool holder and at a reduced distance from one of the sides of said intermediate portion.

To release a length of support wire, it is necessary to manually grasp the intermediate portion without detaching the reel from the cable and, by tightening the hand, to exert pressure on the second part of the locking lever so as to bring it closer to the intermediate portion. This has the effect of causing the first part of the lever to pivot upward, thus unlocking the latch, which is butted up against the first part. To unwind the first few meters of support wire necessary for attaching the young plant, the other hand must be used to pull down on the free end of the support wire in order to get the desired length to unwind. The procedure for releasing additional lengths is essentially the same, but in that case the upper end of the paid-out string supporting the plant is grasped with one hand, and the other hand is then used to tip the lever in the direction of the intermediate portion.

However, a simple and inexpensive device of this kind has the disadvantage of necessitating the repetition of considerable effort to succeed in lifting the paid-out support wire to which the plant (which can weigh on the order of 10 to 20 kg) is attached, so that the spool of wire can be rotated in a controlled manner for a number [of rotations] that is equal to the additional length of wire that is to be paid out. The user has to use both hands simultaneously. Thus, neither hand is free to take hold of a guard rail to prevent falls. As an alternative, it is possible to unwind the spool jerkily, repositioning the locking lever against the latch at each turn. But the resulting jerks will then jostle the creeping plant and may inadvertently cause fruit to drop. Keeping in mind that these troublesome manipulations are performed more than 3 m off the ground, it will be appreciated that the work becomes very tiresome, considering that a greenhouse can require the use of several thousand training devices. In addition, it is not possible to precisely regulate the additional length of support wire that is paid out, since that length has to be a multiple of a rotation of the spool.

### SUMMARY OF THE INVENTION

The present invention provides a simple and easy-to-use training device that makes it possible to release any desired length of support wire and that can be manipulated with one hand.

This is achieved according to the invention by the fact that the reel comprises an immobilizing lever mounted pivotably about a pivot axis between a position of clamping the support wire and position of releasing it, said support wire between disposed, in the clamping position, between a first jaw, which is integral to the immobilizing lever, and a second, fixed jaw opposite the first jaw, and automatic return means for returning said immobilizing lever toward the clamping position.

In the clamping position, the jaws pinch the support wire and serve to frictionally retain it. The radial clamping force is sufficient to create a longitudinal retaining force that opposes the weight of the paid-out wire and the attached plant. Manual pressure applied to a bearing surface of the immobilizing lever generates a rotational torque opposite to that exerted by the return means, thereby causing the first and second jaws to spread apart. This movement brings about the instantaneous and gradual, i.e. non-jerky, release of the support wire, which unwinds from the spool under the effect of the weight of the plant. The greater the manual pressure, the more the radial clamping force decreases, as does the longitudinal retaining force. Thus, merely by adjusting the exerted pressure, the user can very precisely control the length of support wire that is automatically paid out, which length can be arbitrary. When said length reaches the desired length, the user need only relax the manual pressure. This manipulation is performed very simply, with one hand, and with a minimum of effort, since all that is needed is to apply a pressing force to the bearing surface of the immobilizing lever.

In one form thereof, the present invention provides a device for training creeping plants by means of a substantially vertical, flexible support wire, including a reel with quick attach means to effect attachment to a carrying cable and a winding spool on which the support wire is wound and which is mounted rotatably about an axis of rotation, the reel including an immobilizing lever mounted pivotably about a pivot axis between a position of clamping the support wire and a position of releasing it, the support wire being disposed, in the clamping position, between a first jaw integral to the immobilizing lever and a second, fixed jaw opposite the first jaw, and automatic return means for returning the immobilizing lever toward the clamping position, the device being characterized in that the reel includes a wall to which the immobilizing lever is connected by a rectilinear joining element made of deformable elastic material, the joining element constituting the pivot axis of the immobilizing lever.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a right front perspective view of the reel in an example of the training device according to the invention;

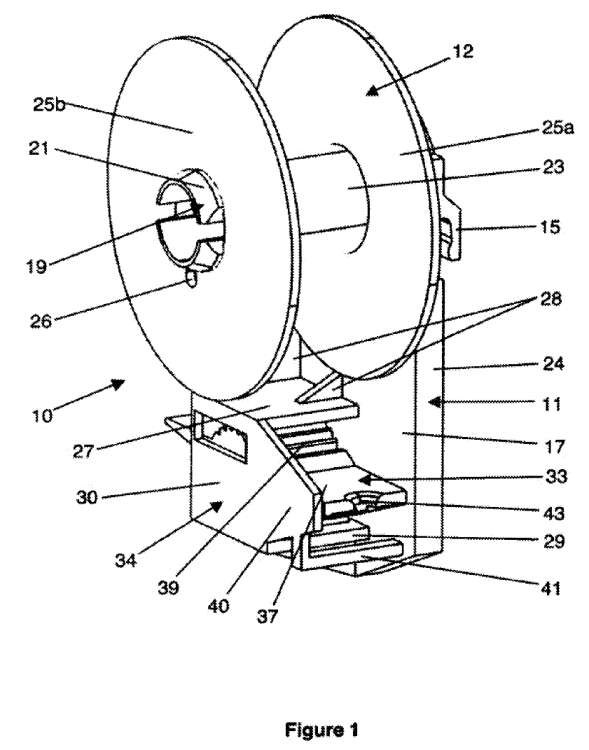

FIG. 2 is a right rear perspective view of the reel of FIG. 1;

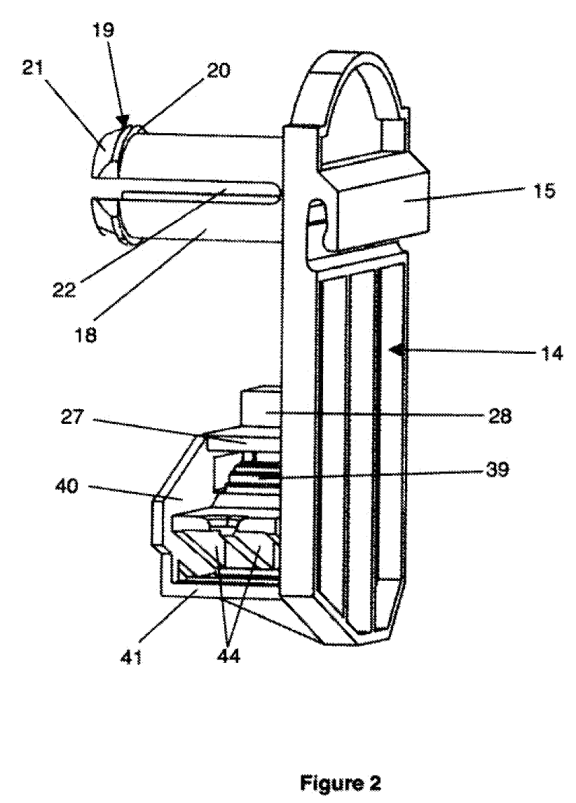

FIG. 3 is a left front perspective view of the reel of FIG. 1; and

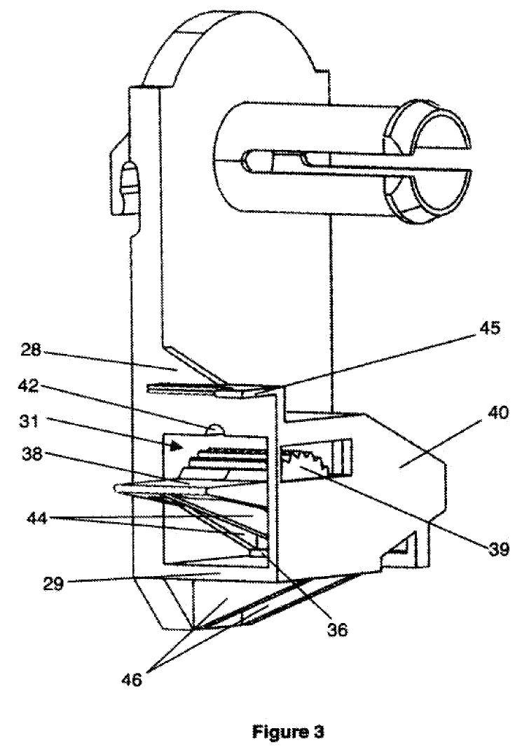

FIG. 4 is a longitudinal section of the reel of the preceding figures.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

Referring to the figures, an exemplary training device according to the invention comprises a reel 10 having a support 11 provided with a flat rectangular frame 24. The reel 10 is further composed of a winding spool 12 for a flexible support wire 13. Said spool 12 is supported by support 11. The reel 10 is designed to be attached to a carrying cable (not shown) disposed several meters off the ground, substantially vertically from a row of plants whose spacing depends on the type of plant concerned. For this purpose, a rear face 14 of flat frame 24 has in its upper portion a hook 15 extending over its full width. These conventional attaching means permit quick attachment of the reel 10 to the carrying cable, as well as easy and very rapid movement of the reel 10 along the cable, in a manner that is perfectly controllable by the user.

The reel 10 allows a free segment 16 of support wire 13 to be released by being unwound from the spool 12. The free segment 16 is designed to extend substantially vertically down to the ground to so that the creeping plant can be secured to it by means of suitable fasteners and guided by it during its growth. The support wire 13, which is of any given diameter, can be a string, a rope, or any other element made of a suitable flexible material.

To effect the simple and removable attachment of spool 12 to support 11, a tubular mounting sleeve 18 extends perpendicularly from the front face 17 of flat frame 24, i.e. the opposite face from rear face 14, at the same height as the hook 15. A retaining stop 19 projects from the outer surface of mounting sleeve 18 at its distal end, that is, the opposite end from the end by which it is connected to flat frame 24. Retaining stop 19 is composed of an inner shoulder 20, connected to the outer surface of the mounting sleeve 18, and an outer chamfer 21. To create the retaining stop 19, the diameter of the cylindrical outer surface connecting inner shoulder 20 and outer chamfer 21 is greater than the inner diameter of the hub 23 of the spool 12.

To make it possible to mount the hub 23 of spool 12 on the outer surface of mounting sleeve 18, rectilinear openings 22 extend axially from the distal end of mounting sleeve 18. During the mounting of spool 12, rectilinear openings 22 encourage radial deformation of the sleeve 18 toward its axis of revolution. Outer chamfer 21 facilitates the engagement of the spool 12 by the free end of the sleeve 18 by converting this axial movement into radial deformation of the sleeve 18. As a result of elastic rebound of the constituent material of the sleeve 18, the inner shoulder 20 then serves to retain the hub of spool 12. Spool 12 is then in the state of being mounted rotatably about an axis of rotation corresponding to the axis of revolution of mounting sleeve 18.

In conventional fashion, the ends of the hub 23 of the spool support the perpendicularly disposed sides 25a, 25b, one of which, 25a, is provided with a starter hole 26 through which the end of the paid-out segment of support wire 13 is passed in order to secure it on the outside of side 25a, for example by making a knot.

Support 11 further comprises a first wall 27 connected perpendicularly to the front face 17 of the flat frame 24 and oriented so as to be parallel to the direction of the carrying cable when it is inserted in the hook 15. Two ribs 28 strengthen the rigidity between flat frame 24 and first wall 27. First wall 27 is disposed below mounting sleeve 18.

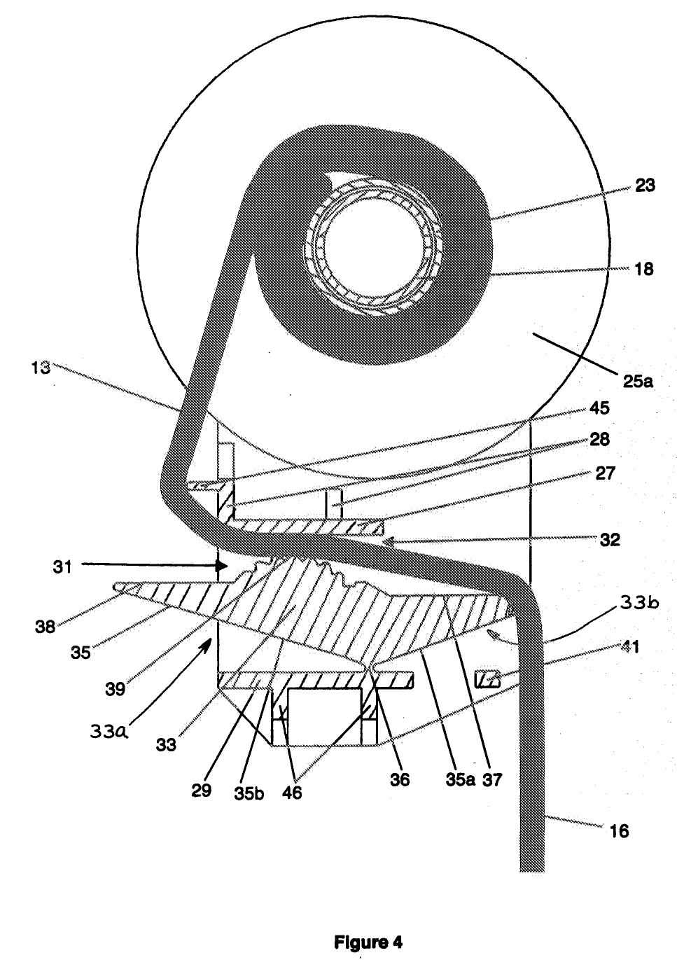

A second wall 29 extends below and parallel to first wall 27. Two ribs 46 strengthen the rigidity between flat frame 24 and second wall 27. First and second walls 27, 29 are linked by a third wall 30 parallel to the flat frame 24. The assembly constituted by flat frame 24 and by walls 27, 29, 30 delimits a compartment 34 communicating with the outside and designed to be traversed by the support wire 13 (FIG. 4), and having, for this purpose, an entrance opening 31 for the support wire 13 coming from the spool 12 (on the left in FIG. 4) and an exit opening 32 (on the right in FIG. 4).

According to the invention, support 11 comprises an immobilizing lever 33, which is elongated in a main direction that is parallel to the direction of the carrying cable when inserted in the hook 15. Immobilizing lever 33 passes through compartment 34 and exits to the outside through openings 30 and 31. The bottom face 35 of immobilizing lever 33, confronting second wall 29, is connected to second wall 29 by a rectilinear joining element 36 made of deformable elastic material. Joining element 36 constitutes a pivot axis of immobilizing lever 33 that is parallel to the axis of rotation of spool 12.

On one and the other side of rectilinear joining element 36 in the main direction of immobilizing lever 33, rectilinear joining element 36 figuratively defines a first portion (on the left in FIG. 4) and a second portion (on the right in FIG. 4) of immobilizing lever 33, which portions are referenced 33a and 33b, respectively. To put it another way, the first portion 33a of immobilizing lever 33 is that portion of immobilizing lever 33 which is delimited by rectilinear joining element 36 in the main direction and which extends across entrance opening 31. The second portion 33b is constituted by the rest of the immobilizing lever 33. In the variant shown, second portion 33b extends in the prolongation of first portion 33a, and across exit opening 32.

In first portion 33a, the top face 37 of immobilizing lever 33 has a flat bearing surface 38 disposed externally to the compartment 34, and a convexity 39 in the shape of a partial cylinder, provided outwardly with notches arranged in the axial direction of said convexity 39. Convexity 39 is situated inside the compartment 34.

With immobilizing lever 33 in the natural position, which depends on how joining element 36 is configured, a manual pressure applied to bearing surface 38 causes immobilizing lever 33 to pivot in such a way that first portion 33a moves away from first wall 27 and second portion 33b moves closer to it. When this pressure is removed, immobilizing lever 33 automatically goes back to its natural configuration as a result of elastic rebound of the constituent material of rectilinear joining element 36.

In the natural configuration of immobilizing lever 33, the apex of convexity 39 is located at a distance from first wall 27. This distance is smaller than the diameter of support wire 13. As a result, when support wire 13 coming from spool 12 traverses compartment 34, passing above immobilizing lever 33, support wire 13 is in the state of being clamped between first wall 27 and convexity 39 (FIG. 4). This phenomenon is considerably reinforced by the downward tension exerted on free segment 16 by the weight of the plant. This tension causes a rotational torque of immobilizing lever 33 in the direction of the clamping of support wire 13. In addition to increasing the clamping force on support wire 13, this rotational torque makes it possible to return immobilizing lever 33 toward the clamping position when it is spaced apart from it.

On the side proximate the exit opening 32, third wall 30 is prolonged by a maintaining wing 40 whose purpose is to guide the support wire 13 coming out of compartment 34. A roughly L-shaped reinforcing element 41 connects flat frame 24 and maintaining wing 40, passing under the second portion 33b of immobilizing lever 33. The support wire 13 coming out of compartment 34 constitutes the free segment 16 and can extend down to the ground.

To increase the precision of the guidance of support wire 13 in the unwinding direction upstream of compartment 34, the upper edge of entrance opening 31, i.e., the corresponding lateral edge of the bottom face of first wall 29, comprises a first channel 42 that is oriented downward parallel to the main direction of immobilizing lever 33. Similarly, downstream of compartment 34, a second channel 43 is provided in the top face 37 of immobilizing lever 33, at the distal end of second portion 33b. Second channel 43 is oriented downward parallel to the main direction of immobilizing lever 33.

The bottom face 35 of immobilizing lever 33 comprises two sections 35a and 35b, which converge toward rectilinear joining element 36. To save on weight, apertures 44 are provided in sections 35a, 35b.

In the variant shown, a deflecting wing 45 extends laterally from the rib 28 located above first channel 42. Said deflecting wing 45 serves to push away the segment of support wire 13 stretched between spool 12 and first channel 42. This expedient limits wear and tear on the support wire 13 as it is being unwound, and decreases the amount of force needed to unwind it.

It will be understood from the foregoing that the immobilizing lever 33 is mounted pivotably between a position of clamping the support wire 13 and a position of releasing it, support wire 13 being disposed, in the clamping position, between convexity 39 and first wall 27. Rectilinear joining element 36 and the rotational torque created by the tension exerted on free segment 16 by the weight of the plant constitute automatic return means for returning immobilizing lever 33 toward the clamping position. Convexity 39 and first wall 27 constitute first and second jaws, respectively, in the action of clamping support wire 13.

Clearly, the automatic return of immobilizing lever 33 toward the clamping position can be brought about by any appropriate means, for example by means of a torsion spring.

When the support wire 13 coming from spool 12 traverses compartment 34, passing above immobilizing lever 33, and immobilizing lever 33 is in the clamping position (FIG. 4), these jaws pinch the support wire 13 and serve to frictionally retain it. The dimensional characteristics of the immobilizing lever 33 and the structural characteristics of the rectilinear joining element 36 are chosen so that the radial clamping force on support wire 13 is sufficient to create a longitudinal retaining force that opposes the weight of free segment 16 and of the attached plant. For a given weight of the plant, the radial clamping force depends on the distance separating second channel 43 and convexity 39 in the main direction of immobilizing lever 33. Manual pressure applied to bearing surface 38 generates a rotational torque opposite to that exerted by the return means, causing convexity 39 to move away from first wall 27. This movement brings about the instantaneous and gradual, i.e. non-jerky, release of support wire 13, which unwinds from the spool 12 under the effect of the weight of the plant. The length of free segment 16 increases. The greater the manual pressure, the more the radial clamping force decreases, as does the longitudinal retaining force. Thus, merely by adjusting the exerted pressure, the user can very precisely control the length of support wire 13 that is automatically paid out, which length can be arbitrary. When said length reaches the desired length, the user need only relax the manual pressure. This manipulation can be performed very simply, with one hand, and with a minimum of effort, since all that is needed is to apply a pressing force to the bearing surface 38 of immobilizing lever 33.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-9. (canceled)

10. A device for training creeping plants by use of a substantially vertical, flexible support wire, said device comprising:
a reel including an attachment component attachable to a carrying cable, and a winding spool on which the support wire is wound, said spool rotatably mounted to said reel about an axis of rotation, said reel further comprising:
an immobilizing lever pivotally mounted about a pivot axis between a first position in which said lever clamps the support wire, and a second position in which the support wire is released and wherein, in said clamping position, the support wire is disposed between a first jaw integral to said immobilizing lever and a second, fixed jaw disposed opposite said first jaw; and
an automatic return structure operable to return said immobilizing lever toward said clamping position, said structure including a rectilinear joining element of deformable elastic material connecting said immobilizing lever to a first wall of said reel, said joining element constituting said pivot axis of said immobilizing lever.

11. The device of claim 10, wherein said reel further comprises a compartment housing said immobilizing lever at a level of said first jaw, said compartment including an entrance opening for the support wire unwinding from said spool, said entrance opening providing free passage to an outside for a first portion of said immobilizing lever that includes a bearing surface disposed externally to said compartment, and an exit opening for the support wire.

12. The device of claim 11, wherein said immobilizing lever includes a second portion extending from said first portion, said second portion extending through said exit opening and having a distal end provided with a second guide element for guiding the wire exiting said compartment.

13. The device of claim 11, wherein an edge of said entrance opening includes a first guide element, said first guide element guiding the support wire unwinding from said spool.

14. The device of claim 11, wherein said compartment includes a second wall disposed opposite said first jaw of said immobilizing lever and said first wall to which said immobilizing lever is connected, said second wall forming said second jaw.

15. The device of claim 10, wherein said first jaw includes a convexity in the shape of a partial cylinder and provided outwardly with axial notches.

16. The device of claim 10, wherein said reel includes a mounting sleeve for mounting said spool, said mounting sleeve comprising:
a free end for engaging said spool;
axial rectilinear openings extending from said free end; and
a retaining stop configured at said free end, and including an inner shoulder and an outer chamfer.

17. The device of claim 10, wherein said attachment component is a hook.

18. The device of claim 10, wherein said pivot axis of said immobilizing lever is disposed parallel to an axis of rotation of said spool.
